(19) United States
(12) Patent Application Publication
(10) Pub. No.: US 2007/0287128 A1
(43) Pub. Date: Dec. 13, 2007

(54) Osteointegrated implant systems

(76) Inventors: Pierpaolo Claudio, Napoli (IT); Francesco Godono, Napoli (IT); Gaetano Marenzi, Napoli (IT); Gilberto Sammartino, Napoli (IT)

Correspondence Address: REED SMITH LLP, 2500 ONE LIBERTY PLACE, 1650 MARKET STREET, PHILADELPHIA, PA, 19103, US

(21) Appl. No.: 11/653,099

(22) Filed: Jan. 12, 2007

(30) Foreign Application Priority Data
Jun. 13, 2006 (IT) NA2006A000075

(51) Int. Cl. A61C 8/00

(52) U.S. Cl. 433/173

(57) ABSTRACT

The present invention is a dental implant for affixing a dental prosthesis (mobile or fixed) to bone tissue to provide a stable integration of the implant with the bone tissue. The implant uses a multifaceted thread, which improves the distribution of loads from the implant to the bone tissue. The multifaceted thread may be of a tapered height adjacent an inserted end, such that the thread forms a self-threading implant, reducing the likelihood of tissue damage resultant from the use of multiple tools to form a thread in bone tissue prior to the insertion of the implant.

### BACKGROUND

The present invention relates to the field of dental implants, and more particularly to osteointegrated dental implants utilizing a threaded body to integrate with bone tissue to provide a fixed mounting of the implant.

Dental implants may be formed by integrating a threaded body into bone tissue to provide a structural foundation for dental prosthetics. Such dental prosthetics are subjected to high loads as a result of pressures generated while chewing. These pressures must be transferred to the underlying bone structure. As the underlying bone structure has material properties significantly different from the materials used for the implant, and as the bone tissue is itself living tissue, particular care must be used to control the transferring of loads from the implant to the bone tissue to minimize dislocation of the implant, as well as the potential of bone absorption.

Typical implants utilize a common helical pair formed on the exterior surface of a stem to provide the structural interface between the implant and the bone structure. Research carried out hereto regarding the problem of stress distribution along the thread of a common helical pair is usually characterized by the assumption that the screw-bolt system is subjected only to the action of an axial load that arise during and at the end of a screw fastening, thus neglecting the presence of internal bending momentums resultant from piecewise dissymmetry of the individual threads.

It is known that the lack of a uniform stress distribution along the thread results from the fact that the joining pressures between the threads of the threaded body and the threaded portion into which the threaded body in reciprocal contact, which is limited inferiorly from the surface of the helicoids, do not present any symmetry with respect to the axis of the screw, not even if the engagement zone would results extended to an n number, although big, of gripping threads. Such a consideration imply the possibility of bending momentums in the stem of the screw, to which in some conditions could correspond maximal tensions in the order of magnitude corresponding to the nominal mean of traction.

Presently, implant screws may evidence non-symmetric loading of the thread/bone interface that with time tends to deviate the original axis of the fixture within the bone. The non-symmetric loading created by an osteointegrated implant having a single thread tends to distort the receiving bone site, thus resulting in the deviation. In the presence of multiple implants that are closely located, the non-symmetric loading can act in concert with loading created by other implants to predispose bone absorption. Finally, the use of a single thread may maximize the concentration of compressive forces that may predispose an implant site to bone absorption.

### SUMMARY OF THE INVENTION

The present invention is embodied in a dental implant having a central body and having a long axis. The central body has an inserted end, an exterior end, an outer radius, an outer surface and a central receptacle for receiving a dental prosthesis. The central receptacle is located adjacent the exterior end. A plurality of helical threads are formed on at least a portion of the outer surface of the body. The threads are located such that the threads are symmetrical with respect to a plane through which the long axis extends, with the threads being formed such that each thread extends to a major thread radius greater than the outer radius. The threads each comprise a first feature and a second feature and a valley formed between the first feature and the second feature. The valley has a valley floor located at a floor radius, with the floor radius being greater than the outer radius of the body, and less than the major thread radius.

In another form, the present invention is embodied in a dental implant having a central body, having a long axis, an inserted end, an exterior end, an outer radius, an outer surface and a central receptacle for receiving a dental prosthesis, with the central receptacle being located adjacent to the exterior end. A plurality of helical threads may be formed on at least a portion of the outer surface of the body, with the threads being located such that the threads are substantially piecewise symmetrical with respect to a plane through which said long axis extends. The threads may be formed such that each thread extends to a major thread radius greater than the outer radius, with the threads each having a first surface, a second surface, a third surface, a fourth surface, and a fifth surface. The first surface may extend from the outer surface and be joined to the second surface, with the second surface being connected to the third surface at an edge of the second surface opposite the connection to the first surface. The third surface may be substantially parallel to the outer surface at a valley radius, with the valley radius being greater than the outer radius of the central body. The third surface may further be connected to the fourth surface at an edge of the third surface opposite to the connection to the second surface. The fifth surface may extend from the outer surface of the central body and be connected to the fourth surface at an edge of the fourth surface opposite to the connection of the fourth surface to the third surface.

### BRIEF DESCRIPTION OF THE FIGURES

FIG. 1 illustrates a simplified model of a dental implant.

FIG. 2 illustrates a helical model for assessing the stresses present between an implant and the surrounding tissue.

FIG. 3 illustrates the pressure components on a portion of the helical surface of FIG. 2.

FIG. 4 illustrates in cross-section an implant utilizing an improved thread geometry.

FIG. 4A illustrates an improved implant as shown in FIG. 4, showing the implant in partial cross-section to illustrate the thread structure and socket.

FIG. 4B illustrates an improved implant as shown in FIG. 4, showing the implant in partial cross-section to illustrate the thread structure and socket, and showing the improved thread geometry in detail.

FIG. 5 comprises a table showing reference geometry for implementations of a helicoids thread according to the present invention.

FIG. 6 illustrates a polar diagram of the geometry of a helicoidal thread according to the present invention.

FIG. 7 illustrates relevant geometry with respect to the presence of 4 load bearing helicoids according to the present invention.

FIG. 8 illustrates relevant geometry with respect to the bone into which an implant may be integrated.

FIG. 9 illustrates relevant geometry with respect to the radius of the implant.

FIG. 10 illustrates relevant geometry with respect to the deformation of the threads and receiving bone structure.

### DETAILED DESCRIPTION OF THE INVENTION

In order to provide a better understanding of the present invention, a discussion of the stresses inherent in a threaded dental implant is provided below. Further, the following conventions are provided:

rᵢ=thread minor diameter

rₑ=thread major diameter

Distribution of the Load on the Helicoids

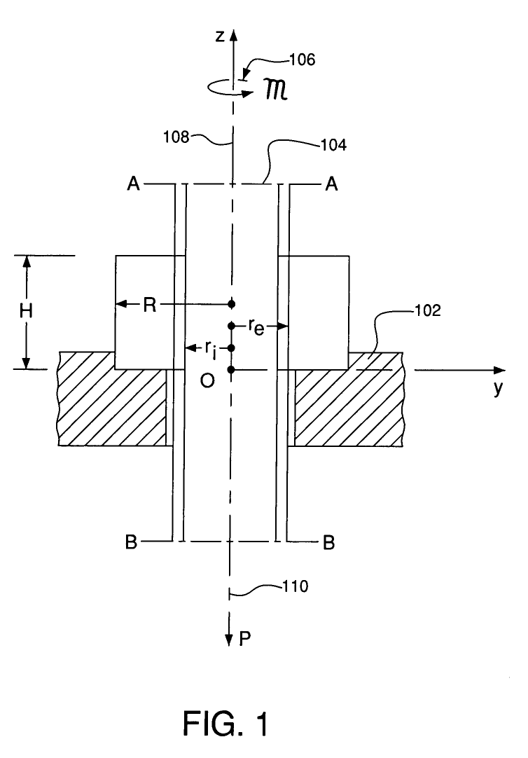

As shown in FIG. 1, the stresses and deformations within the implant may be considered by reference to a fixed nut 102 having an internally threaded bore within the nut and by a screw 104 (representing the implant) which is free to rotate. The screw may be subject to a twisting moment M 106 acting about the long axis of the screw, and to a load P 108 applied parallel to the long axis of the screw.

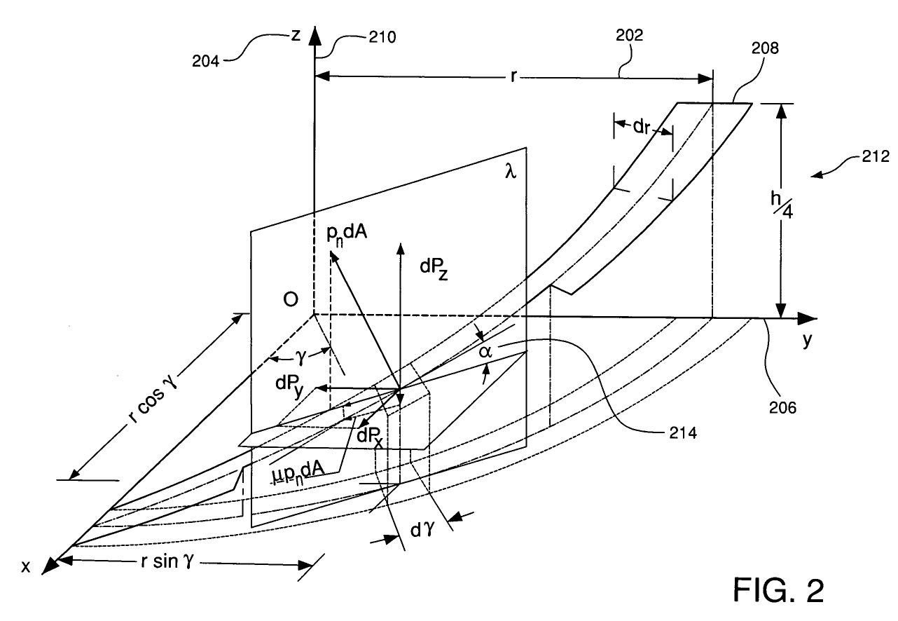

The thread formed on the screw may be modeled as a helix, as shown in FIG. 2. Coordinates r(202), z(204), and γ(206) may be used to define the location of the portion of the helix 208, wherein r is the radial distance from the center axis of the screw 210, and z is the position along the center axis of the screw. Including h (212, the tread of the helix, shown as h/4 since a quarter of a full tread is illustrated), would result in:

$$\begin{matrix}tg α = \frac{h}{2 π r} ( {r}_{1} < r < {r}_{e} ; {α}_{e} < α < {α}_{i} ) & \text{(3.1)} \\ γ = \frac{2 π z}{h} ( 0 < z < H ; 0 < γ < θ ) & \text{(3.2)}\end{matrix}$$

Where α214 is the angle between the helix and the r plane, and H is the length of the screw.

The normal load pₙ on the portion of the helix under consideration may been seen as:

pₙ=F₁(r,z)

μpₙ=tgφF₁(r,z) (3.3)

where φ is the friction angle and [pⁿ and μpₙ] are respectively directed according to the binormal and tangent to the helix with a r radius.

On the helix:

$$dA = \frac{r \cdot d γ \cdot dr}{cos α} \qquad \text{(3.4)}$$

Thus, the forces on the differential area dA may be called:

pₙ dA and μ pₙ dA

which may be resolved along the axis of the left-handed ◯ frame to form the components:

dPₓ=pₙ·(sin α+μ·cos α)·sin γ·dA

dP_{y}=−pₙ·(sin α+μ·cos α)·cos γ·dA

dP_{z}=pₙ·(cos α−μ·sin α)·dA (3.5)

Where the momentums with respect to the same axis may be expressed through the following relationships:

dMₓ=dM_{xy}+dM_{xz}

dM_{y}=dM_{yx}+dM_{yz}

dM_{z}=dM_{zx}+DM_{zy} (3.6)

In which:

dM_{xy}=−z·dP_{y}

dM_{xz}=γ·sin γ·dP_{z}

dM_{yz}=−r·cos γ·dP_{z}

dM_{yx}=z·dPₓ

dM_{zx}=−r·sin γ·dPₓ

dM_{zy}=r·cos γdP_{y} (3.7)

using the formulas (3.4), (3.5), (3.6), and (3.7), one can determine the equilibrium conditions of the screw in the corresponding matrixes:

$$\begin{matrix}- P = {P}_{z} = {\int }_{A} d {P}_{z} = {\int }_{0}^{H} {\int }_{{r}_{i}}^{{r}_{e}} {np}_{n} ( cos α - μ sin α ) \frac{r \cdot d γ \cdot d r}{cos α} & \text{(3.8)} \\ \begin{matrix}M = {M}_{z} = {\int }_{A} d {M}_{z} \\ = - {\int }_{0}^{H} {\int }_{{r}_{i}}^{{r}_{e}} {np}_{n} ( sin α + μ cos α ) \frac{{r}^{2} \cdot d γ \cdot d r}{cos α}\end{matrix} & \text{(3.9)}\end{matrix}$$

which may be resolved once the load functions of (3.3) are identified.

Therefore, when a low value of the h/rₘ ratio (wherein rₘ is the mean thread radius) is assumed, the independence of pₙ from r may be postulated, and, therefore, by simplifying the normal loads of (3.3) results in the equation:

pₙ=F(z)

which is easily determinable, for the assigned geometrical-elastic parameters of the momentum, on the basis of simple congruency conditions of deformation components along the z axis of the screw and of the bolt. Adapting to this case the Klja\check{c}kin procedure, one can assume that for the dependence in the word, the concise formula:

$${p}_{n} = k \cdot cosh [ \frac{2 π m ( H - z )}{h} ]$$

that can be written as:

pₙ=k·cos h[m·(θ−γ)] (3.10)

following the (3.2) and based on the position:

$$θ = 2 π \cdot \frac{H}{h} \qquad \text{(3.11)}$$

Assuming k to be a constant and expressing m through the equation:

$$m = \frac{1}{2 π} \sqrt{\frac{{r}_{e}^{2} - {r}_{i}^{2}}{{R}^{2} - {r}_{e}^{2}} \cdot \frac{{E}_{1} {r}_{i}^{2} + {E}_{2} ( {R}^{2} - {r}_{e}^{2} )}{( {E}_{1} + {E}_{2} ) \cdot {r}_{i}^{2}}} \qquad \text{(3.12)}$$

in which E₁ and E₂ represent the longitudinal elasticity modules of the materials constituting the screw and the bolt, respectively.

Taking into account (3.1), (3.8) and (3.10) and introducing the limits αᵢ and αₑ instead of the correspondent rᵢ and rₑ we can obtain by integration the following:

$$\begin{matrix}P = - k \cdot {h}^{2} \cdot \frac{sinh ( m θ )}{4 n {π}^{2} m} ( {I}_{1} - μ {I}_{2} ) \\ \text{wherein:} & \text{(3.13)} \\ {I}_{1} = cot g {α}_{e} - cot g {α}_{i} \\ {I}_{2} = \frac{1}{2} ( cot {g}^{2} {α}_{e} - cot {g}^{2} {α}_{i} ) & \text{(3.14)}\end{matrix}$$

where for the momentum M of (3.9) in an analogous way we conclude:

$$\begin{matrix}M = - k \cdot {h}^{3} \frac{sinh ( m θ )}{8 n {π}^{3} m} ( {I}_{2} + μ {I}_{3} ) \\ \text{with} & \text{(3.15)} \\ {I}_{3} = \frac{1}{3} ( cot {g}^{3} {α}_{e} - cot {g}^{3} {α}_{i} ) & \text{(3.16)}\end{matrix}$$

Therefore, concerning the constant k, it is clear that because of (3.13) the following results:

$$k = \frac{4 {π}^{2}}{{I}_{2} - μ \cdot {I}_{1}} \cdot \frac{m}{sinh ( m )} \cdot \frac{P}{{h}^{2}}$$

And then for the relation between M and the assigned P, the following relationship may be expressed:

$$M = \frac{h}{2 π} \cdot \frac{P}{η}$$

in which appears the efficiency of the couple

$$η = \frac{{I}_{2} - μ \cdot {I}_{1}}{{I}_{2} + μ \cdot {I}_{3}}$$

which may be resolved by the substitution of I₁, I₂ and I₃ which results in an function in terms of the geometric characteristics αᵢ and αₑ and of the friction coefficient μ. When μ tends to be null it generates the obvious result η=1.

Therefore, using the (3.13) or the (3.15) we can substitute pₙ as expressed in (3.11) in one of the following:

$$\begin{matrix}{p}_{n} = - \frac{4 {π}^{2}}{{I}_{2} - μ \cdot {I}_{1}} \cdot \frac{m \cdot cosh [ m ( θ - γ ) ]}{n sinh ( m θ )} \cdot \frac{P}{{h}^{2}} or & \\ {p}_{n} = - \frac{8 {π}^{3}}{{I}_{2} + μ \cdot {I}_{3}} \cdot \frac{m \cdot cosh [ m ( θ - γ ) ]}{n sinh ( m θ )} \cdot \frac{M}{{h}^{3}} & \text{(3.17)}\end{matrix}$$

From which it is possible to derive for γ=0.

$${p}_{n max} = - 4 {π}^{2} \cdot \frac{m \cdot cth ( m ϑ )}{{I}_{2} - μ \cdot {I}_{1}} \cdot \frac{P}{{h}^{2}} \qquad \text{(3.18)}$$

For γ=θ we have the minimum value pₙₘᵢₙ derived by:

$${p}_{n min} = - \frac{4 {π}^{2}}{{I}_{2} - μ \cdot {I}_{1}} \cdot \frac{m}{n sinh ( m θ )} \cdot \frac{P}{{h}^{2}} \qquad ( {3.18}^{′} )$$

Eccentricity of the Axial Resulting Stress

It is clear that as soon as at least one of the following conditions it is satisfied:

$${M}_{xz} = {\int }_{A} r \cdot sin γ \cdot d {P}_{x} \neq 0 \\ {M}_{yz} = - {\int }_{A} r \cdot cos γ \cdot d {P}_{x} \neq 0 \qquad \text{(3.19)}$$

The component P_{z} that equilibrate the axial load applied to the stem of the pivot will not present a null momentum with respect to a whatsoever straight line which is parallel to the xy plane, from where the projection of the action in that plane of P_{z} will be uniquely identified, in addition to the distance:

$$Δ = \frac{1}{{P}_{z}} \cdot \sqrt{{( {\int }_{A} r \cdot sin γ \cdot d {P}_{z} )}^{2} + {( {\int }_{A} r \cdot cos γ \cdot d {P}_{z} )}^{2}}$$

that represents the translation of the straight line equation with respect to z

y=x·tg ψ

and therefore of the angle ψ, such that:

x_{z}=Δ·cos ψ

y_{z}=Δ·sin ψ

Obtainable using the simple equilibrium equation:

$${\int }_{A} r \cdot sin ( γ - ψ ) \cdot d {P}_{z} = 0$$

That immediately gives:

$$tg ψ = \frac{{\int }_{A} r \cdot sin γ \cdot d {P}_{z}}{{\int }_{A} r \cdot cos γ \cdot d {P}_{z}}$$

When one accounts for the integrals that appear in (3.19) and considering the (3.1), (3.4), (3.5), (3.8), (3.14), (3.16) and (3.17), one can obtain integrating:

$$\begin{matrix}Δ = \frac{h \cdot m}{2 π sinh ( m θ )} \cdot \frac{{I}_{3} - μ \cdot {I}_{2}}{{I}_{2} - μ \cdot {I}_{1}} \sqrt{{I}_{4}^{2} + {I}_{5}^{2}} and & \text{(3.20)} \\ tg ψ = \frac{{\dot{I}}_{4}}{{I}_{5}} where & \text{(3.21)} \\ {I}_{4} = \frac{cosh ( m θ ) - cos θ}{{m}^{2} + 1} & \text{(3.22)} \\ {I}_{5} = \frac{m \cdot sinh ( m θ ) + sen θ}{{m}^{2} + 1} & \text{(3.23)}\end{matrix}$$

having as a consequence:

$${x}_{z} = \frac{h \cdot m \cdot {I}_{5}}{2 π sinh ( m θ )} \cdot \frac{{I}_{3} - μ \cdot {I}_{2}}{{I}_{2} - μ \cdot {I}_{1}}$$

$$and$$

$${y}_{z} = \frac{h \cdot m \cdot {I}_{4}}{2 π sinh ( m θ )} \cdot \frac{{I}_{3} - μ \cdot {I}_{2}}{{I}_{2} - μ \cdot {I}_{1}}$$

So it is demonstrated the existence of the distance Δ and of the destabilizing couple −ΔP.

Actions in Absence of an External Momentum

What has been previously shown is valid when the screw is simultaneously subjected to the action of a load −P and of the momentum M, but it consent to infer rapidly the valid expressions when the screw is subjected only to an external load.

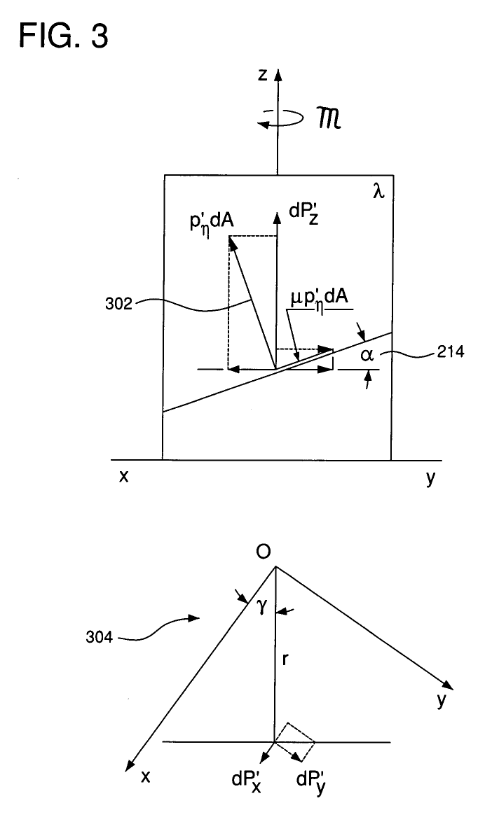

If in fact we speculate the presence of a couple −M₁ such to interest the superficial element dA to the action of multiple units of load pₙ′ and μpₙ′ contained in the plane λ reported in FIG. 2 and directed like in FIG. 3, the load condition will be satisfied from the simple nullification of the applied momentum.

If the motion results assured by the condition M₁>0 any possibility that −P alone could ensure motion by itself is excluded soon after that the momentum is absent; therefore, it will be enough to assess the inequality:

$${M}_{1} = {\int }_{A} d {M}_{z} = {\int }_{A} {np}_{n}^{′} \cdot ( sin α + μ \cdot cos α ) \cdot r \cdot d A \qquad \text{(3.24)}$$

to which it is possible to arrive through the (3.6) and (3.7) as well as through the (3.5) that for this examined case are equal to:

dP′ₓ=−pₙ′·(μ·cos α−sin α)·sin γ·dA

dP′_{y}=pₙ′·(μ·cos α−sin α)·cos γdA

dP′_{z}=pₙ′·(cos α+μ·sin α)·dA

Obviously, it is possible to adopt the (3.10) even for the case under examination, and therefore it is possible to write the equation:

p′ₙ=k′·cos h[m(θ−γ)]

in which, one more time for equilibrium conditions results:

$${k}^{′} = \frac{- 4 {π}^{2}}{{I}_{2} + μ \cdot {I}_{1}} \cdot \frac{m}{sinh ( m θ )} \cdot \frac{P}{{nh}^{2}} \qquad \text{(3.25)}$$

By which the (3.24) is reduced in force of the (3.14) and (3.16) by the simple relation:

$$μ > \frac{{I}_{2}}{{I}_{3}} \qquad \text{(3.26)}$$

That gives back for αᵢ=αₑ=α the well known condition:

μ>tgα (φ>α)

Therefore, if the (3.24) is satisfied, the most significant magnitudes characteristic of the examined problem, such as the p′ₙₘₐₓ, Δ′, P′ₓ, P′_{y}, x′_{z},y′_{z}, and so on, marked by an apex in order to be distinguished from the corresponding in the first scenario, can be directly deduced substituting −μ instead of μ.

Limiting ourselves to transcribe the equation relative to Δ′, namely the expression becomes:

$${Δ}^{′} = \frac{h \cdot m}{2 π sinh ( m θ )} \cdot \frac{{I}_{3} + μ \cdot {I}_{2}}{{I}_{2} + μ \cdot {I}_{1}} \sqrt{{I}_{4}^{2} + {I}_{5}^{2}} \qquad \text{(3.27)}$$

it is possible to state, by confrontation with the (3.20), and for the condition Δ′<Δ, that the fastening phase needs to be reviewed regarding the flexion overload associated to it, which is more dangerous of the other, resulting for it more the maximal pressure as in the (3.18) that in this case are equal to:

$$P max = \frac{- 1}{{nh}^{2}} \frac{4 {π}^{2}}{{I}_{2} + μ \cdot {I}_{1}} \cdot m \cdot cot gh \cdot m θ P$$

### [This is obtained for simple substitution of the generic pressure (3.25)].

If we really examine the condition of two (2) threads (n=2) that already satisfies a symmetric condition we have:

$$P max = \frac{- 1}{2 {h}^{2}} \frac{4 {π}^{2}}{{I}_{2} + μ \cdot {I}_{1}} \cdot m \cdot cot gh \cdot m θ P$$

Therefore, the stress is the half of that associated to only one thread. For n=3 the stress will be a third (⅓) with respect to the one that is applied to the screw with one thread and so on for n number of threads.

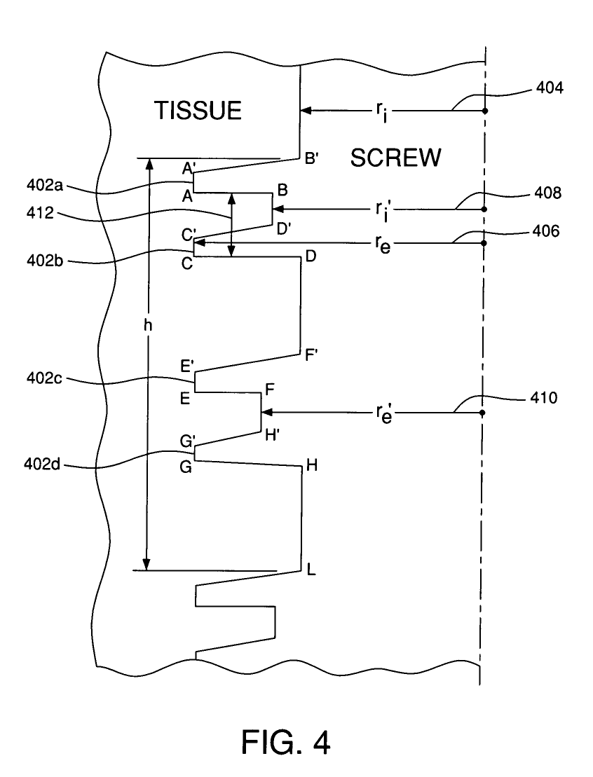

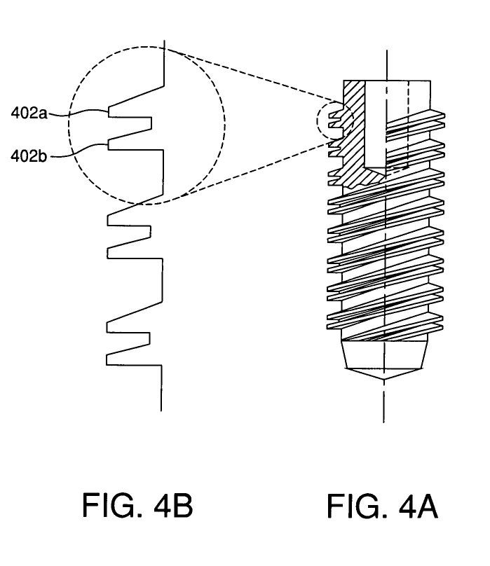

It is known that in an osteointegrated screw implant, the reaction to an axial load, as an accumulation of all the specific pressures acting on the helicoids forming the surfaces delimiting the screw threads, it is not centered, but presents a finite arm also in the presence of an infinite number of threads. This arm, for the axial acting load, represents a flexing momentum causing a flexing stress that is added to the axial load determining undesirable axial deviations at first only temporary and elastic, but that with a persistent load becomes permanent. Implants nowadays on the market are made with 2 threads, and are characterized by a distribution of the load on the two helicoids that even though are generating a symmetry of the resulting arms (3.27) are not able to preserve the obtained symmetry in the presence of external forces acting outside the joining of the two resultants. Therefore, the aforementioned implants give rise to new flexion that creates other dissymmetries determining further increments of contact pressure on the helicoids. This system of osteointegrated implant with an “eliminated reactive dissymmetry” (ERD) by being constituted from a single “articulated” thread, which presents two or more load bearing helicoids, is able to highly reduce the specific contact pressures that are unloaded on the threads. Additionally, it guarantees that the reactions to the external centered load will be centered on the vertexes of a polygon in which a further external load will not result in flexions by keeping its symmetry. The proposed configuration of the implant is represented in FIG. 4 in which the thread has a profile that can be constituted by four bearing loads helicoids characterized by equal or different geometries.

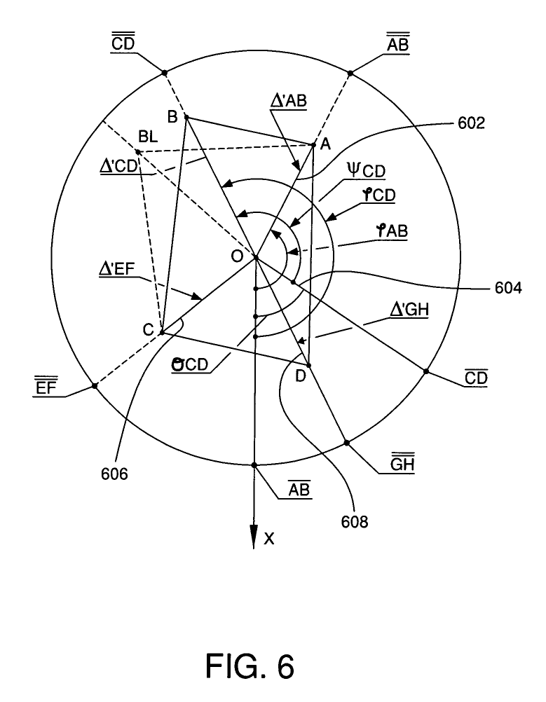

The articulation is represented by the following in FIG. 6: a first straight helicoid generated by the “AB” line, a second straight helicoids “CD” that offers more contact surface with respect to the previous and which represents the depth of the thread, a third straight helicoid “EF” that offers less contact surface with respect to the two previous helicoids (AB and CD) and a final oblique helicoid generated by the line GH. The profile of the thread is completed by the helicoids A₁B₁, C₁D₁, E₁F₁, G₁H₁ which are all oblique and cylindrical surfaces AA₁, BD₁, CC₁, DF₁, EE₁, FH₁, GG₁, HL. The aforementioned cylindrical surfaces undertake different radiuses comprised between the internal radius rᵢ of the thread (diameter at the bottom of the thread) and the external radius rₑ of the screw (diameter of the screw) which defines its caliper. (FIG. 4a)

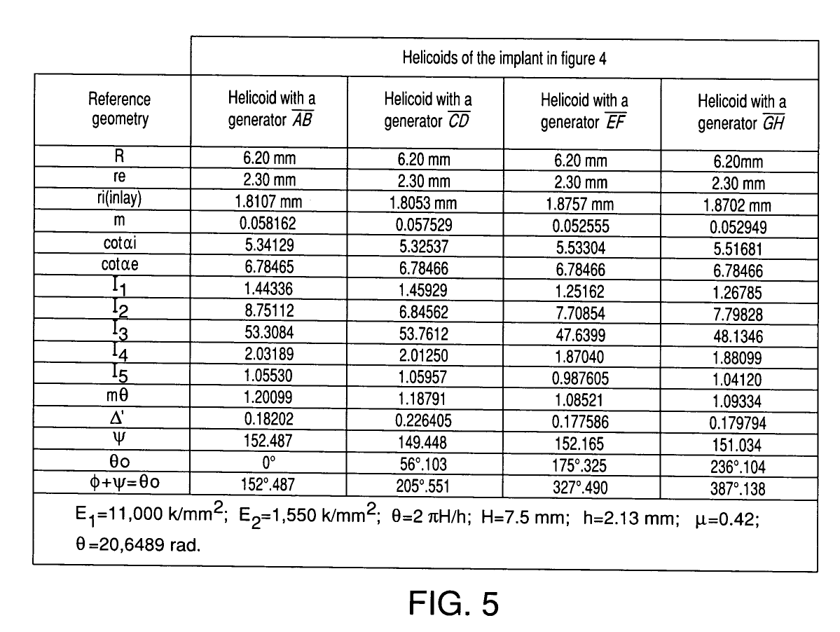

The radiuses r′ and re′ are different from ri so that the single thread can acquire more strength since the third power of its length influences its fragility against the square its thickness, therefore smaller length results in more strength than it would be possible to achieve with a variation of the square of its thickness. With regards to FIG. 4 and to the relations 3.11, 3.12, 3.14, 3.16, 3.20, 3.21, 3.22 and 3.23, a table (Table A, shown in FIG. 5) is shown in which, with different values of H, h, E1, E2 and μ (reported on the bottom of the table), the magnitudes referred in the relations 3.11, 3.12, 3.14, 3.16, 3.20, 3.21, 3.22 and 3.23 are revealed. In particular, for various helicoids A̅B̅, C̅D̅, E̅F̅, and G̅H̅, as shown in FIG. 4, are reported the arms Δ′ of the resultant of the pressures acting on such helicoids. It is also reported the angle Ψ that defines the position of Δ′ in the polar reference shown in FIG. 6.

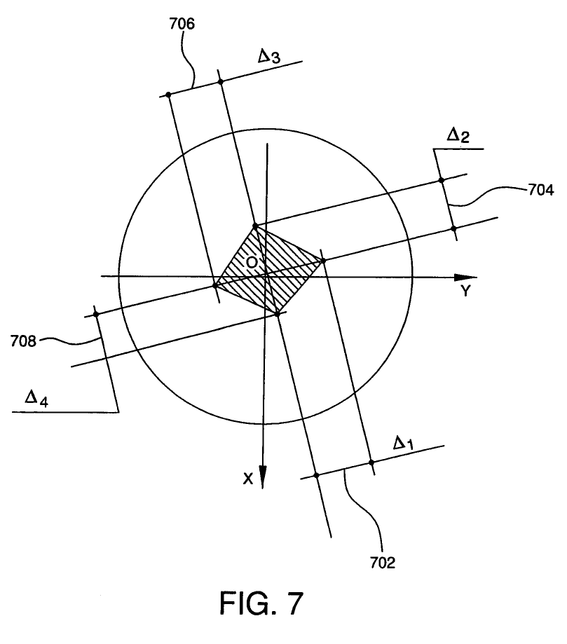

With this implant configuration it is understandable that in the presence of 4 load bearing helicoids if we vary the angle θ we can bring to perfect symmetry the 4 reactions of the relative helicoids positioning them symmetrically in couples and obtaining in the final straight surface a quadrangle in which eventual not centered actions do not result in undesirable flexions. The arms Δ1, Δ2, Δ3, Δ4, in the Cartesian reference Oxy reported in the FIGS. 2 and 3, will be placed at the vertex of a quadrangle following the diagram in FIG. 7, eliminating in this way the potential dissymmetry derived from bending loads.

In FIG. 6 there is shown the representation of the quadrangle for the results described in table A on which the resultants of the distribution of the stresses of the single helicoids are applied to the vertexes.

If we overlap the first helicoid with the origin of the polar reference \vec{OX}, with generator A̅B̅ of FIG. 4, the reaction to a load centered on the axis will be positioned in the spot A of FIG. 6 with the anomaly:

φ A̅B̅=ψ A̅B̅=152°.487

and vector radius

Δ′AB=0.18202 mm.

Regarding the second helicoid C̅D̅, that is set back from the first of the quantity A̅C̅ of FIG. 4, on the diagram of FIG. 6, with the anomaly θCD=56°.103 and the resultant of the stresses with φCD=205°.551 the reaction to a load centered on the axis will be positioned in the spot B. In the same way we can obtain the spots C and D that complete the aforementioned quadrangle.

Because the angles θo which appear in table A relative to the helicoids A̅B̅, C̅D̅, E̅F̅, and G̅H̅ are bound to the axial quota of the spots A, C, E and G of FIG. 4, if one operates a variation of quota we obtain a variation of θo and therefore results possible to alter advantageously the area of the quadrangle ABCD of FIG. 6.

In fact, if we lower the axial quota of the helicoid C̅D̅ of FIG. 4 of just 6% of the tread h, the spot B of FIG. 6 is moved in B₁ and the quadrangle ABCD becomes AB₁CD increasing beneficially its area of 12% circa. Operating on the other helicoids we can rapidly arrive to the best optimized building solution.

On the other hand, a solution of one or two load bearing helicoids (thread with one or two spires) presents dissymmetries that in the first case (1 spire) is equal to its relative delta, and in the second case (2 spires) positioning the reactions on a diameter offers the possibility of flexions with a flexion plane which is perpendicular (normal) to the joining of the two arms.

The different shape of the threads of the implant screw with respect to that of the mother-screw (represented by bone tissue) yield to the different intrinsic resistance of the two materials (screw and bone tissue) and to the different deformability, which is linked to the different elastic modules. The outline of the implant screw thread that we propose will be always undertaking a thickness that is inferior to that of the mother-screw which is constituted by the bone structure around the implant in the way that an external load will provoke a similar reaction in the two structures.

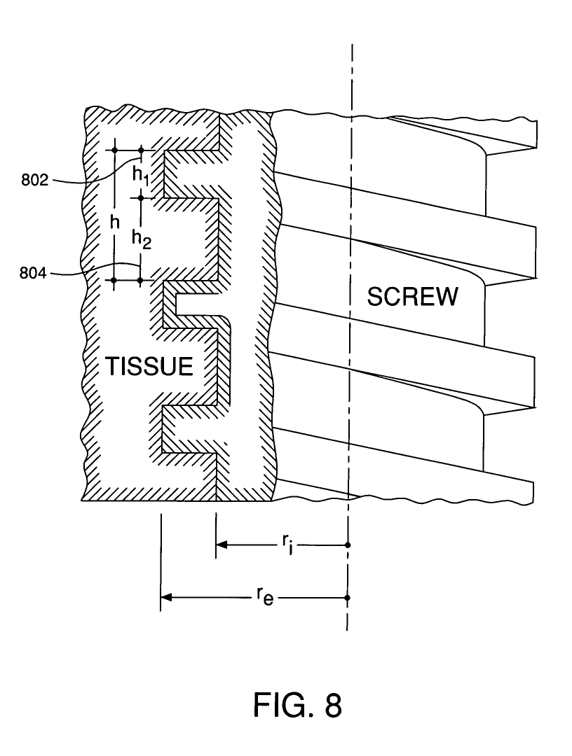

In FIG. 8 we examine a generic coupling of screw and mother-screw (bone tissue) characterized by an elastic module E₁ for the screw, and E₂ for the mother-screw (bone tissue), in which the threads have thicknesses h₁ and h₂, respectively.

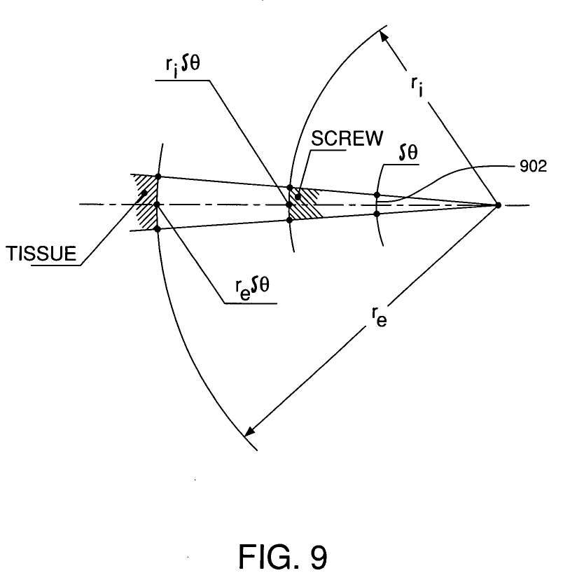

In FIG. 9 we have isolated an infinitesimal angular element (δσ) of the two threads involved in which the inertial flexing momentums I₁ and I₂, are worth respectively:

$$\begin{matrix}{I}_{1} = \frac{1}{I2} \cdot {r}_{i} \cdot δσ \cdot {h}_{1}^{3} ; \\ And & \text{(3.28)} \\ {I}_{2} = \frac{1}{I2} \cdot {r}_{e} \cdot δσ \cdot {h2}^{3} ; & \text{(3.29)}\end{matrix}$$

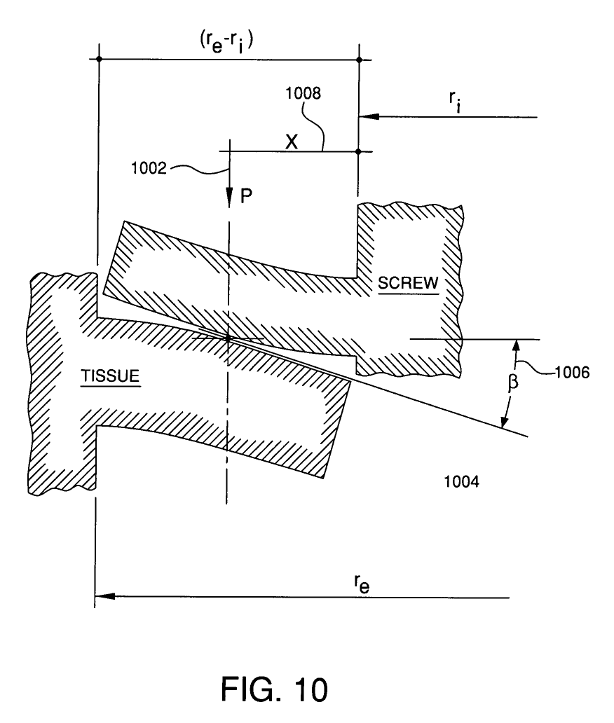

In FIG. 10 we have represented the coupling of two elements of elementary angular amplitude. δσ of FIG. 9 under a load P and in a deformation phase have in common the tangent that, with respect to the perpendicular plane to the axis of the screw will form the angle β. Calculating the inclination to the unknown position x of contact, for the two elements, screw and mother-screw (bone tissue) in FIG. 10, we have the following:

For the screw:

$$β = \frac{{Px}^{2}}{2 {E}_{1} {I}_{1}} \qquad \text{(3.30)}$$

For the bone tissue:

$$β = \frac{{P ( {r}_{e} - {r}_{i} - x )}^{2}}{2 {E}_{2} {I}_{2}} \qquad \text{(3.31)}$$

Equalizing and simplifying we obtain:

$$\frac{{x}^{2}}{{E}_{1} {I}_{1}} = \frac{{( {r}_{e} - {r}_{i} - x )}^{2}}{{E}_{2} {I}_{2}}$$

Putting for ease the following:

$$k = \frac{{E}_{2} {I}_{2}}{{E}_{1} {I}_{1}} \qquad ( 3.32 )$$

than we have:

$$\frac{x}{{r}_{e} - {r}_{i}} = \frac{1}{1 + \sqrt{k}} \qquad ( 3.33 )$$

If we take into consideration the (1) and (2) we have:

$$k = \frac{{E}_{2} {I}_{2}}{{E}_{1} {I}_{1}} = \frac{{E}_{2} \cdot {r}_{e} \cdot {h}_{2}^{3}}{{E}_{1} \cdot {r}_{i} \cdot {h}_{1}^{3}} \qquad ( 3.34 )$$

from which we can calculate that, taking into consideration the (3.33), the position x taken by the threaded coupling is a function of the radiuses rₑ and rᵢ and also of the thickness h₁ and h₂ which relates the different tension capacity of the materials chosen for the implant and the bone itself.

Application

Examining numerous implants we have found the following data:

rₑ=1.9÷2.5 mm

rᵢ=1.4÷2.0 mm

From which results the relation:

$$\frac{{r}_{e}}{{r}_{i}} = 1.25 \div 1.36 \qquad ( 3.35 )$$

If we assign to a titanium screw:

E₁=11,000 kp/mm (3.36)

and for the bone mother-screw:

E₂=1,550 kp/mm (3.37)

and imposing the wide field for the for the relation between the height of the threads h₁ and h₂ of FIG. 8, we have:

h₂/h₁=1÷2 (3.38)

and because the (2) gives for the extreme values of (3) and (11):

$$k = \frac{1 \text{,} 550}{11 \text{,} 000} ( 1.25 \div 1.36 ) \cdot ( 1 \div 2 ) = 〈 \begin{matrix}0.176 \\ 0.383\end{matrix}$$

With a variability field of k that when it is substituted in the (3.34) it will provide for the relation

$$\frac{x}{( {r}_{e} - {r}_{i} )}$$

the following field:

$$0.617 < \frac{x}{{r}_{e} - {r}_{i}} < 0.704 \qquad ( 3.39 )$$

And by being very restricted the variability field of x it does not appear wrong to assume as likely and with good approximation the mean value:

$$\frac{x}{{r}_{e} - {r}_{i}} = \frac{0.704 + 0.617}{2} = 0.661 \qquad ( 3.40 )$$

which itself confirms what we anticipated in the introduction. This data let us also declare that because the mother-screw (bone tissue) is more fragile (E₂=1,550 kp/mm²) with respect to the screw (E₁=11,000 kp/mm²) the contact between the two helicoids can not happen past the halfway of the depth of the thread (re−ri).

Therefore, accepting the mean value (3.40) the (3.33) will provide:

$$k = {( \frac{1}{0.661} - 1 )}^{2} = 0.263$$

Substituting in (3.28)

$$0.263 = \frac{1 \text{,} 500}{11 \text{,} 000} \cdot \frac{{r}_{e}}{{r}_{i}} \cdot \frac{{h}_{2}^{3}}{{h}_{1}^{3}}$$

with rₑ=2.5 and rᵢ=2 (those values are relative to known and commercially available implants), we have the following:

$$\frac{{h}_{2}}{{h}_{1}} = \sqrt[3]{0.263 \cdot \frac{11 \text{,} 000}{1 \text{,} 550} \cdot \frac{2}{2.5}} = 1.148 \qquad ( 3.41 )$$

with h₂+h₁=h we can obtain the following:

$$\begin{matrix}{h}_{1} = 0.466 h \\ {h}_{2} = 0.533 h\end{matrix} \} \qquad ( 3.42 )$$

Whereas for example, if we want to amplify the field relative to the elasticity modules of the implant and of the bone using a screw of different material (metallic or not metallic) which may have a different modulus of elasticity from the previous one, on a bone with weaker module of elasticity, for example substitute in 3.36 and 3.37, E′=25,000 and E=1,000, the relationship

$$\frac{h 2}{h 1}$$

shown in 3.41 becomes 1.753 with the heights in 3.42 equal to h1=0.363 and h2=0.637. This shows how by increasing the difference between the elastic characteristics of the implant and that of the bone

$$( \frac{E 1}{E 2} )$$

it is necessary to increase accordingly the thickness of the mother screw.

The equation 3.42 points out the urgency to differentiate the thickness of the screw and of the mother-screw (bone tissue) threads according to the amount of depth of the thread (re−ri) and the different elasticity of the implant E₁ and of the bone E₂.

This invention will make a better use of the tension capacity of either materials (the implant and the bone). In fact, the (3.42) offer the greatest thickness h₂ to the bone, which has less tension capacity, and the smallest thickness h₁ to the implant, which obviously has the greatest tension capacity.

The proposed solution may include a thread with integrated surface configuration which forms a “macrostructure” of the fixture that can ensure an augmented surface of contact between bone and implant.

The proposed solution may include a thread with an integrated surface configuration which forms a “macrostructure” of the fixture that can ensure a better distribution of the chewing load with respect to implant screws having one or more threads.

The proposed solution may include a thread with an integrated surface configuration which forms a “macrostructure” of the fixture that can reduce the appearance of compressive peaks which could favor bone absorption.

The proposed solution of innovative threaded coupling may be useful in all those orthopedic cases in which the joining of the prosthesis is secured by traditional thread couplings. Additionally, the proposed solution may be used in all those mechanic, hydraulic, bioengineering occasions in which the classical thread coupling could determine anomalies in the function because of loading dissymmetries.

The proposed solution for the connection between the abutment (prosthesis pillar) and the implant ensures a better distribution of the occlusal load on the screw itself that reduces the stress among the various implant-prosthetic components.

The proposed solution has the advantage that if we associate to the different helicoids that define the geometric profile of the thread with integrated surface its own global angle θ, then the terminal truncation offers a gradual engagement when one inserts the implant screw in the bone to create a self threading implant screw.

Fixtures with one thread with an integrated surface can greatly reduce the specific contact pressures between bone and implant with the advantage of better distribution of occlusal forces. This condition augmenting greatly the contact surface between the bone and the implant favors the implant stability augmenting the osteointegration process.

All of the aforementioned points are valid for the external configuration of the implant screw as well as for the internal connection with the prosthetic internal abutment. The proposed solution, also with respect to an eventual solution with two or more threads, ensures a further improvement of the superficial distribution of the force transference of the fixture on the surrounding bone tissue.

The proposed implant, as we have demonstrated, eliminates to the root all the inconveniences of currently used threads such as: the dissymmetry of the distribution of the stress and therefore the rise of bending momentums that deflect the longitudinal axis of the implant; the elevated specific stresses; the unjustified thickness assigned to the threads of the screw and mother screw. It is also characterized by having the same type of thread (with all the relative advantages) for the connecting part between the implant and the crown. In fact, the connection of the crown is usually screwed inside the implant with a normal thread that produces all the disadvantages previously discussed. Therefore, it is clear the necessity to provide also for this innovative coupling the eligible articulated profile previously described. It is the case to note that with two traditional threads, one for the implant and one for the crown, the reaction of the eccentricity may be doubled, doubling all the inconveniences that may derive. Therefore, the innovative implant proposed has, for the implant part (external thread) and for the crown (internal thread), the articulated thread.

The knowledge of the loads on osteointegrated implants has been always directed toward fixtures with one thread neglecting some of the biomechanical aspects. Only an accurate knowledge of the dissymmetry phenomenon and of those factors determining it can induce to modify the morphology of the single threaded screws. Therefore, the proposed invention can not be attributable to any prior art or intuition, but arises from accurate evaluations.

What is claimed is:

1) A dental implant, said implant comprising:
a body, said body having a long axis, an inserted end, an exterior end, an outer radius, an outer surface and a central receptacle for receiving a dental prosthesis, said central receptacle being located adjacent said exterior end; and
a plurality of helical threads formed on at least a portion of said outer surface of said body, said threads being located such that said threads are symmetrical with respect to a plane through which said long axis extends, said threads being formed such that each thread extends to a major thread radius greater than said outer radius, said threads each comprising a first feature and a second feature and a valley formed between said first feature and said second feature, said valley having a valley floor located at a floor radius, said floor radius being greater than said outer radius of said body, and less than said major thread radius.

2) A dental implant according to claim 1, wherein said first feature has a first feature major radius and said second feature has a second feature major radius, and wherein said first feature major radius is greater than said second feature major radius, and wherein said second feature major radius is greater than said floor radius.

3) A dental implant according to claim 1, wherein said first feature has a first feature major radius and said second feature has a second feature major radius, and wherein said first feature major radius is substantially equal to said second feature major radius, and wherein said first feature major radius is greater than said floor radius.

4) A dental implant according to claim 3, wherein said first feature is located closer to said exterior end than said second feature as the thread spirals around said at least a portion of said body, and wherein said first feature has a first surface and a second surface, said second surface being substantially orthogonal to the outer surface of said body.

5) A dental implant according to claim 4, wherein said second surface is located closer to said inserted end than said first surface.

6) A dental implant according to claim 5, wherein said first surface forms an angle with respect to said outer surface of said body, said angle being between approximately 45 degrees and 85 degrees.

7) A dental implant according to claim 5, wherein said second feature has a third surface and a fourth surface, said third surface being substantially normal to the outer surface of said body.

8) A dental implant according to claim 7, wherein said third surface is located closer to said inserted end than said fourth surface.

9) A dental implant according to claim 8, wherein said fourth surface forms an angle with respect to said outer surface of said body, said angle being between approximately 45 degrees and approximately 85 degrees.

10) A dental implant according to claim 1, wherein said valley floor is an arcuate surface.

11) A dental implant according to claim 3, wherein said first feature further comprises a fifth surface, said fifth surface substantially parallel to said outer surface, sad fifth surface connecting said first surface and said second surface.

12) A dental implant according to claim 3, wherein said second feature further comprises a sixth surface, said sixth surface being substantially parallel to said outer surface, said sixth surface connecting said third surface and said fourth surface.

13) A dental implant according to claim 12, wherein said major thread radius diminishes adjacent said inserted end.

14) A dental implant according to claim 12, wherein said outer radius diminishes adjacent said inserted end, and wherein said major thread radius diminishes adjacent said inserted end and wherein said major thread radius and valley radius equal said outer radius adjacent said inserted end.

15) A dental implant according to claim 1, wherein said outer radius diminishes adjacent said inserted end, and wherein said major thread radius diminishes adjacent said inserted end, and wherein said major thread radius and valley radius equal said outer radius adjacent said inserted end.

16) A dental implant, said implant comprising:
a body, said body having a long axis, an inserted end, an exterior end, an outer radius, an outer surface and a central receptacle for receiving a dental prosthesis, said central receptacle being located adjacent said exterior end; and
a plurality of helical threads formed on at least a portion of said outer surface of said body, said threads being located such that said threads are substantially piecewise symmetrical with respect to a plane through which said long axis extends, said threads being formed such that each thread extends to a major thread radius greater than said outer radius, said threads each comprising a first surface, a second surface, a third surface, a fourth surface, and a fifth surface, said first surface extending from said outer surface and being joined to said second surface, said second surface being connected to said third surface at an edge of said second surface opposite said connection to said first surface; said third surface being substantially parallel to said outer surface at a valley radius, said valley radius being greater than said outer radius, said third surface further being connected to said fourth surface at an edge of said third surface opposite said connection to said second surface; said fifth surface extending from said outer surface and being connected to said fourth surface at an edge of said fourth surface opposite said connection of said fourth surface to said third surface.

17) A dental implant according to claim 15, wherein the connection between the first surface and the second surface comprises a sixth surface, said sixth surface being substantially parallel to said outer surface.

18) A dental implant according to claim 16, wherein the connection between the fourth surface and the fifth surface comprises a seventh surface, said seventh surface being substantially parallel to said outer surface.

19) A dental implant according to claim 17, wherein said fifth surface is substantially orthogonal to said outer surface.

20) A dental implant according to claim 18, wherein said second surface is substantially orthogonal to said outer surface.

21) A dental implant according to claim 19, wherein said major thread radius decreases adjacent said inserted end.

22) A dental implant according to claim 15, wherein the connection between the fourth surface and the fifth surface comprises a seventh surface, said seventh surface being substantially parallel to said outer surface.

23) A dental implant according to claim 15, wherein said first surface extends from said outer surface at an angle of approximately 45 degrees to approximately 85 degrees.

24) A dental implant according to claim 15, wherein said fourth surface is angled approximately 45 degrees to approximately 85 degrees with respect to said outer surface.

25) A dental implant according to claim 15, wherein said fifth surface is substantially orthogonal to said outer surface.

26) A dental implant according to claim 15, wherein said second surface is substantially orthogonal to said outer surface.
